(19) United States
(12) Patent Application Publication
(10) Pub. No.: US 2003/0050799 A1
(43) Pub. Date: Mar. 13, 2003

(54) Permission based marketing for use with medical prescriptions

(76) Inventors: Richard Jay, Costa Mesa, CA (US); David Grant, Costa Mesa, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/116,704

(22) Filed: Apr. 3, 2002

Related U.S. Application Data
(60) Provisional application No. 60/281,390, filed on Apr. 3, 2001.
(60) Provisional application No. 60/336,907, filed on Nov. 7, 2001.

(51) Int. Cl. G06F 17/60

(52) U.S. Cl. 705/2; 705/10

(57) ABSTRACT

An application reviews a patient's medical profile, and selects medical products or services to be presented to the patient based on the patient's medical profile such as medical history, diagnosis, prescription, and so forth. An advertisement or price discount for the selected medical products or service is printed and given to the patient. The application preferably resides in a computing device 116 at the doctor's office, and the advertisement or discount is also preferably printed on a printer 118 at the doctor's office and given to the patient at the doctor's office.

### RELATED APPLICATIONS

This application claims priority under 35 U.S.C. 119(e) from U.S. Provisional Application No. 60/281,390, filed Apr. 3, 2001 and titled “Point of Care Clinical and Administrative Management System” and from U.S. Provisional Application No. 60/336,907, filed Nov. 7, 2001 and titled “Medical Service and Prescription Management System.” The above-referenced provisional applications are hereby incorporated by reference into the present application.

### BACKGROUND OF THE INVENTION

1. Field of the Invention

This invention relates to the field of marketing medical products and services to patients.

2. Description of the Related Art

As patient information is being stored in electronic form, patient privacy has become an important issue. Patient information such as patient's demographic data, diagnosis and prescription, medical history, family medical history are preferably kept confidential and not released to marketing agencies. On the other hand, organizations that provide medical products or services desire to reach patients with particular medical profiles, and to offer advertisement, price discounts, or clinical study enrollment offers to patients with particular profiles. Patients can also benefit from learning about or receiving discounts on products and services that suit their needs. It is desirable to give patients information and discounts on products and services that suit their needs, to allow organizations to inform these patients of products and services that suit their needs, and to maintain patient privacy at the same time.

### SUMMARY OF THE INVENTION

One aspect of the invention relates to a computing device for facilitating the marketing of medical products or services to patients. The computing device includes a patient profile module that stores at least a medical profile of a patient, a marketing storage module that stores marketing offers for medical products, medical services or both, and a selection module configured to select one or more marketing offers from the stored marketing offers based on the stored medical profile of the patient.

Another aspect of the invention relates to a method for facilitating the marketing of medical products or services to patients. The method includes reviewing the medical data of a patient, selecting one or more marketing offers for the patient based on the review, and printing at an office of a doctor of the patient the selected marketing offers.

### BRIEF DESCRIPTION OF THE DRAWINGS

FIG. 1 illustrates an overview for one embodiment of the described prescription and medical service management system.

FIG. 2 illustrates one embodiment of a login screen of a point-of-care device.

FIG. 3 illustrates one embodiment of a patient queue screen of a point-of-care device.

FIG. 4 illustrates one embodiment of a patient queue screen of a point-of-care device, with a popped-up portion of command list.

FIG. 5 illustrates one embodiment of a favorites management screen of a point-of-care device.

FIG. 6 illustrates one embodiment of a settings screen of a point-of-care device.

FIG. 7 illustrates one embodiment of a patient prescription history screen of a point-of-care device.

FIG. 8 illustrates one embodiment of a patient prescription history details screen of a point-of-care device.

FIG. 9 illustrates one embodiment of a patient allergy/miscellaneous medications screen of a point-of-care device.

FIG. 10 illustrates one embodiment of a patient allergy/miscellaneous medications screen of a point-of-care device, with a popped-up portion of command list.

FIG. 11 illustrates one embodiment of a patient allergy edit screen of a point-of-care device.

FIG. 12 illustrates one embodiment of a patient miscellaneous medications edit screen of a point-of-care device.

FIG. 13 illustrates three drug search screens of one embodiment of a point-of-care device.

FIG. 14 illustrates one embodiment of an off-formulary warning screen of a point-of-care device.

FIG. 15 illustrates one embodiment of a coverage warning screen of a point-of-care device.

FIG. 16 illustrates one embodiment of a drug interaction/allergy/duplication warning screen of a point-of-care device.

FIG. 17 illustrates one embodiment of a prescription tablet screen of a point-of-care device.

FIG. 18 illustrates one embodiment of a prescription review screen of a point-of-care device.

FIG. 19 is a flowchart illustrating an overview of one embodiment of a process using the disclosed system.

FIG. 20 is a flowchart illustrating one embodiment of a process of conducting medical tests for a patient.

### DETAILED DESCRIPTION OF PREFERRED EMBODIMENTS

The following description and figures describing the preferred embodiment are made to demonstrate one configuration of a system. It is not intended to limit the disclosed concepts to the specified embodiments. A “system,” “application,” “module” or “device” as used herein may refer to any combination of software, firmware, or hardware used to perform the specified function or functions. A plurality of systems, applications, modules, devices or databases may be combined into a smaller number of units. One system, application, module, device or database may be separated into multiple units. Systems, applications, modules, devices and databases may reside at different physical locations connected through a wired or wireless network including the Internet.

The term “doctor” is used in the application to refer to a physician or other healthcare worker, including an emergency room healthcare worker. The term “drug” or “prescription” not only refers to prescription or over-the-counter medications, but may also refer to therapies or lab tests performed for a patient. The term “synchronizes” refers to the downloading or uploading of data between a PDA and a desktop computer in a preferred embodiment, and also refers to the transmitting, transferring or copying of data between two computing devices. The term “medical products or services” refers to products or services related to a patient's medical profile. For example, a woman's maternity dress or a baby's crib, being related to the woman's pregnancy as a medical condition, may be considered “medical products” in the context of providing marketing offers matched with patient medical profiles.

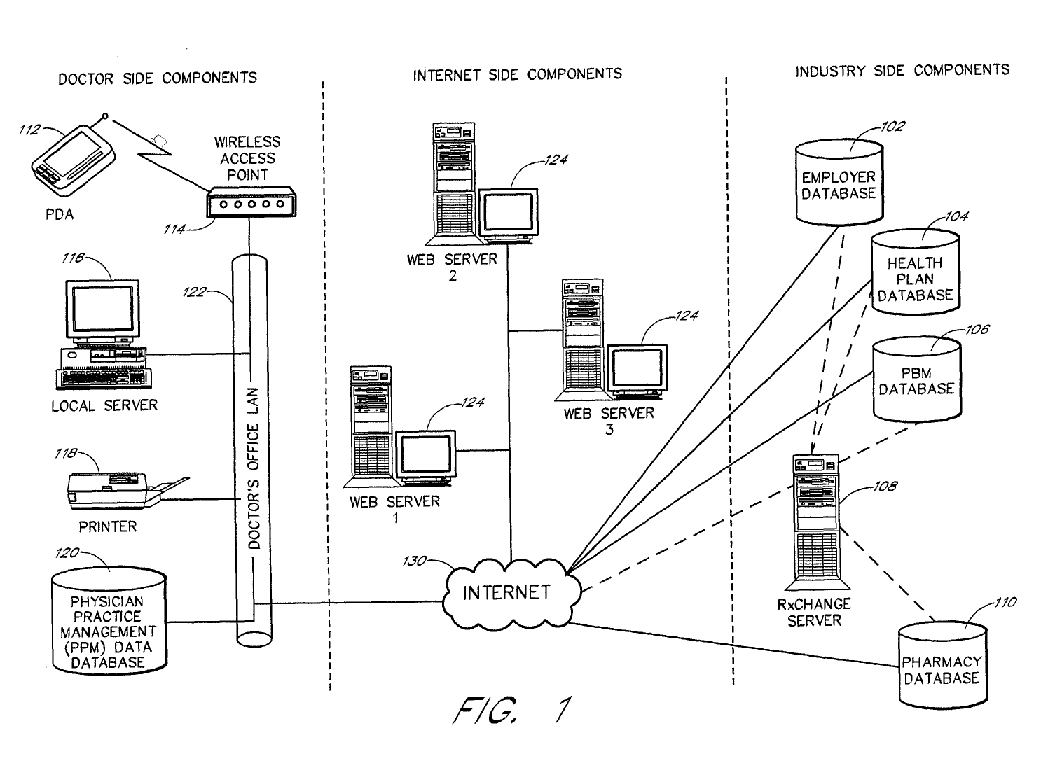

FIG. 1 illustrates an overview for one embodiment of the described prescription and medical service management system. For ease of description, the components shown in FIG. 1 are categorized into three general groups. The first group includes the “industry side” components for industry organizations such as PBM's, health plan providers, and pharmacies, shown on the right side of FIG. 1. They include an employer database 102, a health plan database 104, and a PBM database 106. A RxChange server 108 and a pharmacy database 110 may also be included.

The second group includes “doctor side” components located in a doctor's office and related to a doctor or medical group's medical practice, shown on the left side of FIG. 1. In one preferred embodiment, these may include a point-of-care device (such as a PDA) 112, a wireless access point 114, a doctor's desktop computer 116, a printer 118, a physician practice management (PPM) database 120 and a doctor's office network 122. A doctor's office may refer to a clinic for a doctor or a group of doctors, a hospital, a nursing home, or any facility that provides direct medical care to patients.

The third group includes “Internet side” servers 124 and occupies the middle portion of FIG. 1. A computer network such as the Internet 130 may be used for communicating between the doctor side components and the industry side components. It should be noted that the three groups are categorized for ease of description only. For example, the RxChange server 108 may also be categorized as a web server 124 located among the Internet side components. The health plan database 104, the PBM database 106 and the PPM database 120 may be directly connected to a Internet site and served by web servers 124, and therefore categorized as Internet side components.

Referring to the right portion of FIG. 1, the employer database 102 includes data about an employer's rules and guidelines, which are negotiated with its health care provider(s) and made known to the employees of the company. These rules may include limitations on coverage such as an annual limit on coverage or a policy excluding certain types of treatment (e.g. chiropractic or massage therapy) from coverage at the employer's expense. In addition to storing the rules regarding coverage, the employer database 102 may also include such information as the names of the covered employees, as well as the names of any other individuals covered under the same policy (e.g. spouse, children or other live-in dependents), and demographic data (e.g., address, phone number, age, gender) of the covered individuals. Data related to optional coverage available through the employer may also be stored.

The employer database 102 may be maintained directly by the employer itself, or by the health plan provider(s) selected by the employer. In either case, the health plan provider(s) will desirably have access to the information stored in the employer database 102 in order to properly process claims made against the health plan. Although the employer database 102 is shown schematically as independent from the health plan database 104, the data stored in the employer database 102 may be stored within the same repository as the health plan data without altering the nature of the described system.

The health plan provider data is generally stored in the health plan database 104, which is managed by the health plan provider itself, or by a company hired by the health plan provider for the purpose of managing this data. This data includes the health plan provider's rules regarding coverage and exclusions, and data related to the employers that the health plan provider serves. For instance, coverage rules may include a list of the doctors that fall within the plans of the health plan provider and how those doctors are treated (e.g. whether the doctor is part of the HMO coverage for the plan, a PPO for the plan, or whether the doctor is covered in some other way), as well as information relating to rules regarding referrals to specialists.

The PBM database 106 includes information related to what coverage the PBM will provide to health plan providers regarding prescription medication. In particular, the PBM data includes the formulary for the particular PBM. The formulary includes a listing of medications and treatments covered by the PBM and the degree to which (i.e. what portion of their cost) they are covered by the PBM when filling prescriptions for its member health plans. Although the PBM database 106 is shown schematically as independent from the health plan database 104, the PBM data may be stored within the same repository as the health plan data without altering the nature of the described system. A plurality of employers, health plan providers, and PBMs may combine their respective data into one or more databases. As described below, the health plan database 104 or the PBM database 106 may also store patients' prescription data received from the doctor's offices and prescription filling data received from pharmacies.

The formulary is typically maintained by the PBM. The continuous updating of the covered drugs within the formulary, as well as the continuous updating of the degrees to which these drugs are covered is a time consuming and data intensive task. It is important for the PBM to have this data easily and quickly accessible to doctors who may be prescribing drugs using one of the PBM's member health plans.

The pharmacy database 110 provides information such as drug availability in the pharmacy. In a preferred embodiment, the pharmacy database 110 connects to an inventory and ordering system of the pharmacy to provide the availability of drugs at particular stores. Drug price information may also be included in the pharmacy database 110. In one arrangement, each pharmacy store or pharmacy chain has its own pharmacy database 110. In another arrangement, a plurality of pharmacy chains share a pharmacy database 110 maintained by the RxChange server 108.

As drug availability and price information is of particular use to PBM's who are paying for covered prescription medication, PBM's may desire access to the pharmacy database 110. In particular, the PBM's and the pharmacy database 110 may communicate using existing standards for data exchange between them, such as those defined by the National Council for Prescription Drug Programs (NCPDP). The NCPDP provides a known universal interface for communication with retail pharmacies by PBM's. The industry side systems in FIG. 1 may be connected in a variety of ways, for example by the Internet, Intranets, virtual private networks, and so forth.

In one embodiment, a RxChange server 108 serves the PBM database 106. The RxChange server 108 may be owned by a PBM and located within a firewall of the PBM. The RxChange server 108 may also serve the PBM databases of a plurality of PBM's. In one embodiment, the RxChange server 108 can also serve the health plan database 104 and optionally the employer database 102. The RxChange server 108 can also handle data communication between the local server 116 and the employer database 102, the health plan database 104, and the PBM database 106. The RxChange server 108 as shown in FIG. 1 may represent a plurality of connected servers. Although FIG. 1 displays a RxChange server 108 and three “web servers” 124, it should be understood that one or more RxChange servers 108 or one or more servers 124 can function together or in place of each other.

Referring to the left portion of FIG. 1, the doctor side components include a local server 116 for processing and storing electronic data. The local server 116 is typically a desktop computer or a plurality of connected desktop computers. The doctor side components also include one or more point-of-care devices 112, wireless communications access points 114 for connecting the point-of-care devices 112 to the local server 116, a printer 118, a physician practice management (PPM) database 120, and a doctor's office network 122. Although the terms “local server” and “doctor side components” are used for ease of description, it is to be understood that such components can be located away from a doctor's physical office but connected by a network.

The local server 116 stores and manages data regarding patient scheduling, payments, billing, patient records, and such other information for the running of a clinical medical practice. The local server 116 receives health plan data and PBM data from the health plan database 104 and the PBM database 106. The local server 116 may also receive drug availability and price information from the pharmacy database 110.

The point-of-care device 112 may include a personal digital assistant (PDA), portable computer, network appliance, computer terminal, programmable cell phone or other electronic device that the doctor uses as he or she works with patients. The device 112 can be connected to the local server 116 to download or upload data.

In a preferred embodiment, the point-of-care device 112 can be connected wirelessly to the local server 116. For example, the point-of-care device 112 can be equipped with a wireless Ethernet card conforming to the IEEE 802.11 wireless standard. This wireless network card operates to communicate with other 802.11 compliant hardware, which may include other wireless Ethernet adapters or a wireless access point 114.

The wireless access point 114 is connected to the local server 116 via a network connection, and provides a relay function for wireless devices within range of the access point 114 (typically a few hundred feet). Although FIG. 1 shows only a single wireless access point 114 and a single wireless device 112, it may be desirable in certain circumstances for multiple access points to be used in order that a large area has complete wireless network coverage. In these configurations, a given wireless device is able to “roam” from the coverage zone of one access point 114 to another. Additional access points can be added to the network. Multiple mobile devices 112 can be supported simultaneously by a single access point 114. In another embodiment, the access point 114 is not a wireless access point, but a wired connection, and the point-of-care devices 112 are connected to the local server 116 by wire.

In a preferred embodiment, the point-of-care device 112 is a hand-held computing device such as a PDA. A PDA can be connected to a network, for example, via a wireless Ethernet adapter. Commercially available PDAs include Compaq iPaq, HP Jornada, Vadem Clio, Palm handheld, Handspring Visor, Psion, and so forth. PDAs may operate on a variety of operating systems, including Windows CE, PalmOS, EPOC or others. In a preferred embodiment described herein, the point-of-care device 112 is a Compaq iPaq PDA running Windows CE from Microsoft.

As noted above, tablet computers, laptop computers or other computing devices may also be used in place of a handheld PDA device to access the system. Examples of tablet computers include the Qbe from Aqcess Computers, the 6600 series of computers from Intermec, the Point and Stylistic series of computers from Fujitsu, and others. Any computer that can be connected to a network wirelessly, for example with an 802.11b or other wireless Ethernet card, may be used as a point-of-care device 112. Computers may operate using any of a variety of operating systems, including Windows CE, Linux, Unix, Windows 2000, Windows XP, BeOS, Windows 98, Windows ME, Apple System 9, Apple OS X, an embedded operating system, and so forth. Any computer that can be connected to a network by wire can also be used as a point-of-care device 112. The point-of-care device 112 may be configured to work with a variety input devices, such as keyboards, keypads, touch pads or touch screens, voice input and others.

It should be noted that although the point-of-care device and other devices are described herein as “connected” and shown as such in FIG. 1, the operation of the system does not require that all such systems be connected at all times to all other systems. In particular, the point-of-care device may be temporarily disconnected from the network without effecting its operation. Those functions that take place within the point-of-care device as described herein and illustrated in the accompanying FIGURES and do not rely on the actual transmission of data to or from other systems may be performed without an active connection to the network. For instance, because all of the formulary and patient data for any current patients is transferred to the point-of-care device during synchronization, there is no need to contact any other system via the network in order to write a prescription, perform drug interaction or allergy checking, perform formulary alternative processing, or confirm the prescription. Synchronization is described more fully below.

Only those functions which require the transfer of data to or from the point-of-care device require an active network connection. These functions include loading new patient data, updated formulary or pharmaceutical data, or other synchronization processes, as well as transmitting a prescription to the appropriate pharmacy and health plan providers. If these functions are to be attempted while the device is not connected, the operations will be stored in a cache on the point-of-care device, and then processed at the next opportunity that a connection is present to the doctor's office system.

Because most of the databases of information are only changed periodically (e.g., the formulary rules are not generally updated every single day), the synchronization process will only need to transmit new information to the point-of-care device sporadically, rather than continuously. This conserves the available bandwidth between the point-of-care device and the remainder of the doctor's systems, and also allows for the unconnected operation of the point-of-care device. It should also be noted that the point of care device may be connected to the appropriate systems via remote connections such as via a Virtual Private Network (VPN), dialup connection, via the Internet, or any other remote access technique as is known in the art. Because a constant connection is not required, this allows a doctor or other practitioner using the point-of-care device to perform any necessary operations, even when physically remote from his office if the appropriate connection means are available.

A printer 118 may be provided in order to print out prescriptions or other information for a patient or doctor. The printer may be a standard network capable printer that can be connected to either the local server 116 directly, or to the network 122 within the doctor's office. The doctor's office network 122 is desirably a local area network (LAN), but can also be another network such as a virtual private network (VPN) or a wide are network (WAN). In another embodiment, the components 112, 114, 116, 118 and 120 can also communicate using the Internet directly.

The physician practice management (PPM) database 120 stores data which is made available to the doctors in order to specify the health plan coverage for patients. For each of the patients of the doctor, the PPM data identifies the health plan of the patient and the PBM that provides formulary services for the patient. The PPM data may be downloaded periodically from the health plan database 104 and the PBM database 106. For example, the PPM data may be downloaded daily using a standard protocol such as FTP via the Internet. In one arrangement, after a complete set of data has been downloaded from the health plan database 104 and the PBM database 106, only updates to the PPM data are downloaded daily.

In another embodiment, the doctor side components do not include a PPM database 120 for storing the PPM data. Instead, the doctor uses the local server 116 or the point-of-care device 112 to directly access the information from the health plan database 104 and the PBM database 106.

Referring to the middle portion of FIG. 1, The components shown in FIG. 1 include a plurality of servers 124. Also shown in this portion of the diagram is the Internet 130. The Internet 130 is a global network of computers. The structure of the Internet, which is well known to those of ordinary skill in the art, includes a network backbone with networks branching from the backbone. These branches, in turn, have networks branching from them, and so on. Routers move information packets between network levels, and then from network to network, until the packet reaches the neighborhood of its destination. From the destination, the destination network's host directs the information packet to the appropriate terminal, or node.

In one advantageous embodiment, the Internet routing hubs comprise domain name system (DNS) servers, as is well known in the art. DNS is a Transfer Control Protocol/Internet protocol (TCAP/IP) service that is called upon to translate domain names to and from Internet Protocol (IP) addresses. The routing hubs connect to one or more other routing hubs via high-speed communication links.

The Internet 130 may be used in the described system to provide communication between any of the computers or components described herein. Access to the Internet can be realized using TCP/IP and a variety of other protocols (such as File Transfer Protocol, Hypertext Transport Protocol, HTTP-Secure, Simple Object Application Protocol, and telnet) and in a variety of formats (such as Hypertext Markup Language and Extended Markup Language). Security may be implemented using a variety of methods, including Secure Socket Layer (SSL) encryption, PGP encryption, firewalls, and others.

The Internet 130 provides a means to connect the various components described herein. For example, the local server 116 can connect to the health plan database 104 and to the PBM database 106 using the Internet. Methods such as VPN tunneling or requiring passwords can be used to provide security. Components can also establish direct network communications. Whenever information is described herein as being sent or copied from one system to another, the information may be passed using any communications medium including the Internet.

The servers 124 send data from the industry side components to the local server 116. Such data include formularies and insurance coverage policies, and drug use recommendations and drug availability. Such data also include periodic updates. The data are sent to the local server 116. In one embodiment, the data can be sent directly to the doctor's point-of-care device 112. The servers 124 also receive data from the local server 116, for example the data associated with the prescriptions which are written by the doctors.

A group of three servers 124 are shown in FIG. 1, however any number of servers may be used as may be appropriate to the application and the number of doctors and PBM's which are making use of the system. The functions of the servers 124 may be separated in a variety of ways. For instance, the servers 124 can all store identical data and handle requests based upon which machine has the available processing power when the request is received, and then update the data stored on the other machines. Alternately, the servers 124 can each perform separate parts of the server function. For example, one server 124 stores the electronic pharmacopoeia (a collection of prescription writing recommendations such as suggested dosage for each drug), while another handles the storage of prescription transactions, and a third handles the updating and storage of the formularies for various PBM's.

With respect to the communication and storage of data, a patient's transaction data is preferably separated from the patient's identity information, in order to protect the patient's privacy, to guard against security breaches, and to comply with regulations. For example, the local server 116 sends a patient's prescription data to the health plan database 104 or the PBM database 106. The local server 116 also sends data about the patient's visiting session to the health plan database 104 to collect payment for the doctor from the health plan provider. The local server 116 may also send the patient's prescription data to a pharmacy database 110, and the pharmacy database 110 may send data to the health plan database 104 or the PBM database 106 to get reimbursement after the prescription is filled. For each of these communications of transaction data, the patient's name, address and other identity information are preferably excluded from the sent data. The patient is preferably identified by an identification code, such as an insurance number issued by the health plan provider. Many health plan providers issue an insurance card with an insurance number to each of its policy holders.

The patient's name, address and other identity information are preferably stored at secured locations on the local server 116, secured locations in the health plan database 104 and secured locations of other servers or databases, and preferably not combined with the transaction data to form records. Therefore, even if the transaction data communication over the network is compromised, or even if the transaction data stored on the servers or databases are compromised, the patient's identity information is still secure at the secured locations. The patient's identity information can also be stored at a different server or a different database with better security. Security arrangements such as firewalls and others can be used to provide secured locations.

When the patient's identity information is needed, for example when the health plan provider sends a billing statement to the patient, a program retrieves the patient's identity information from its secured location in the health plan database 104, retrieves the patient's transaction data from another location in the database 104, and produces the billing statement. The patient's identity information and transaction data can be linked by keys, such as the patient's identity code.

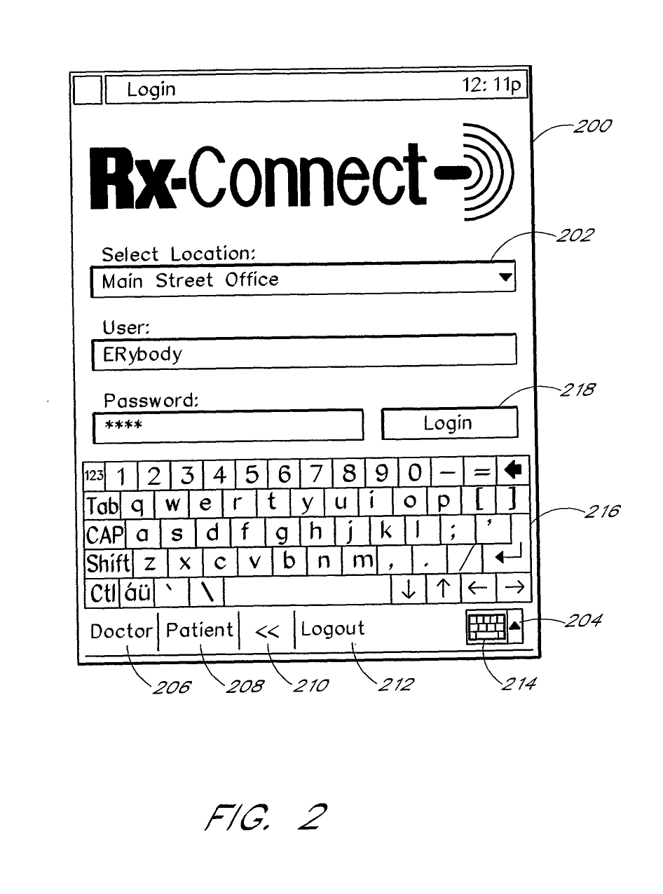

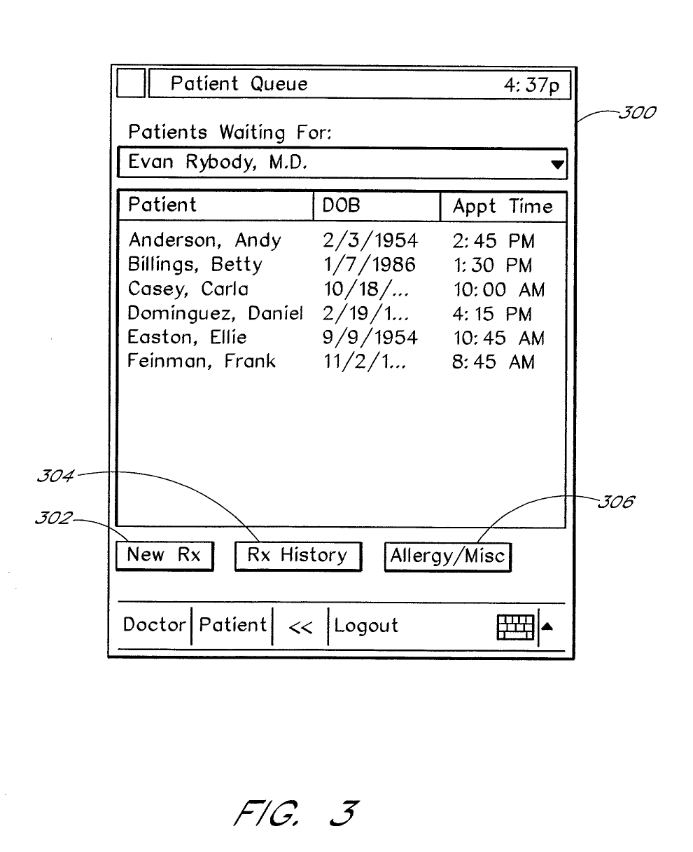

Although the servers 124 are shown in FIG. 1 as Internet side components, some or all of the servers 124 may be located on the industry side. For example, a server 124 may be located within a PBM's firewall to handle the PBM's formulary updates. The servers 124 can analyze data to assist organizations in decision making. For example, the servers 124 analyze the prescriptions written by the doctors to identify the most popular drugs for certain symptoms or diseases, and to identify the most popular drugs that are not on the formulary of a PBM. The PBM's can then update the formulary to better serve the doctors and patients. FIG. 2 illustrates one embodiment of a login screen 200 of a PDA 112. The login screen 200 includes a pull-down menu 202 that allows the selection of a doctor's office location. Optionally, a location may be entered using the keyboard 216, which automatically appears or accessed by hitting the keyboard icon 214. The doctor name may be selected from a pull-down menu or may be entered using the keyboard 216. In the embodiment shown in FIG. 2, the password is case sensitive, expires every 120 days, is alphanumeric and must be at least 4 characters. After entering his or her name and password, the doctor hits the “Login” button 218 to proceed to a “Patient Queue” screen of FIG. 3.

As an alternate means to authenticate a doctor to the PDA, various techniques other than passwords may be used. These may include biometric systems for identifying a doctor based upon such identifying characteristics as fingerprints, handwriting, signature, voice, face or retinal scans.

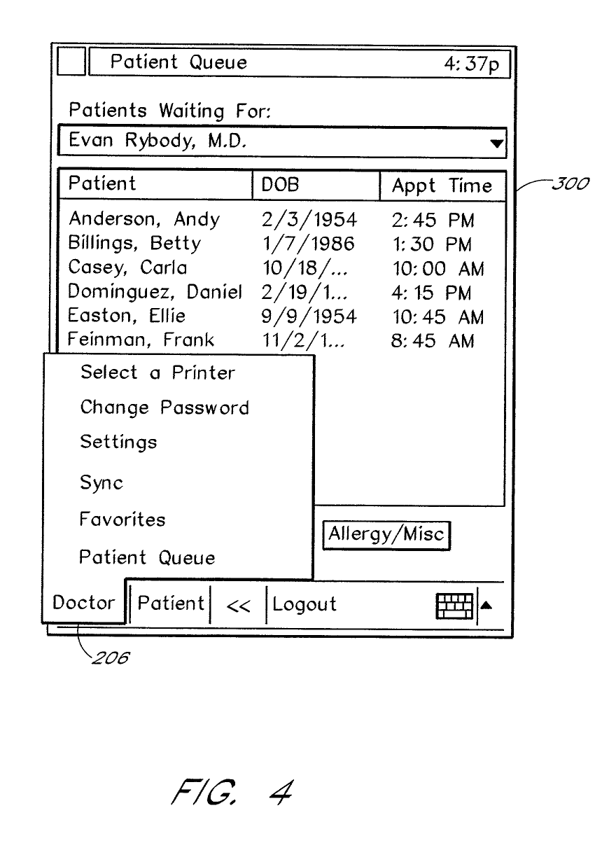

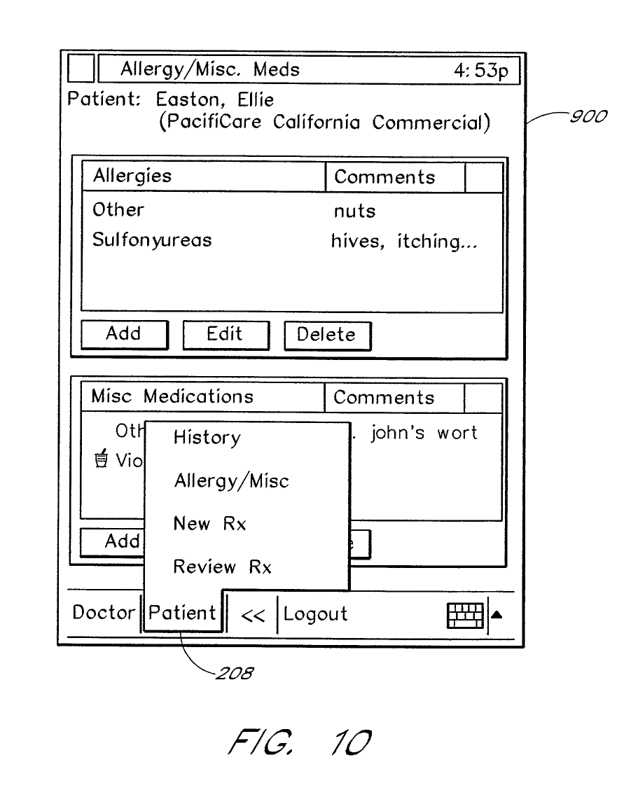

Still referring FIG. 2, the Toolbar 204 also includes command icons including the “Doctor” icon 206 (to be described in connection with FIG. 4), the “Patient” icon 208 (to be described in connection with FIG. 10), the “<<” icon 210 and the “Logout” icon 212. The “<<” icon 210 may also be referred to as the “back” icon and returns to the last screen that was accessed. The “Logout” icon 212 may be used to log the doctor out and return the point-of-care device 112 to the “Login” screen. This may prevent a new doctor from picking up a device and prescribing medication for a patient under another doctor's name, as well as ensuring that each doctor is presented with his or her own schedule of patients and not the schedule of another doctor.

After the doctor logins in, the point-of-care device 112 searches for patients scheduled to visit the doctor on the present day, and displays the list of patients on the point-of-care device 112. FIG. 3 illustrates one embodiment of a “Patient Queue” screen 300 of a PDA 112. The screen 300 displays a list of patients who are scheduled to see the doctor. In one embodiment illustrated in FIG. 3, the patients are displayed in alphabetical order. In another embodiment, the patients are displayed according to their appointment times on the present day.

The list of patient appointments are stored in the local server 116, and copied to the point-of-care device 112 by synchronization. Information for a walk-in patient without appointment is entered in the local server 116 and copied to the point-of-care device 112 by synchronization. In another embodiment, Information for a walk-in patient can also be entered directly in the point-of-care device 112 and then copied to the local server 116 by synchronization.

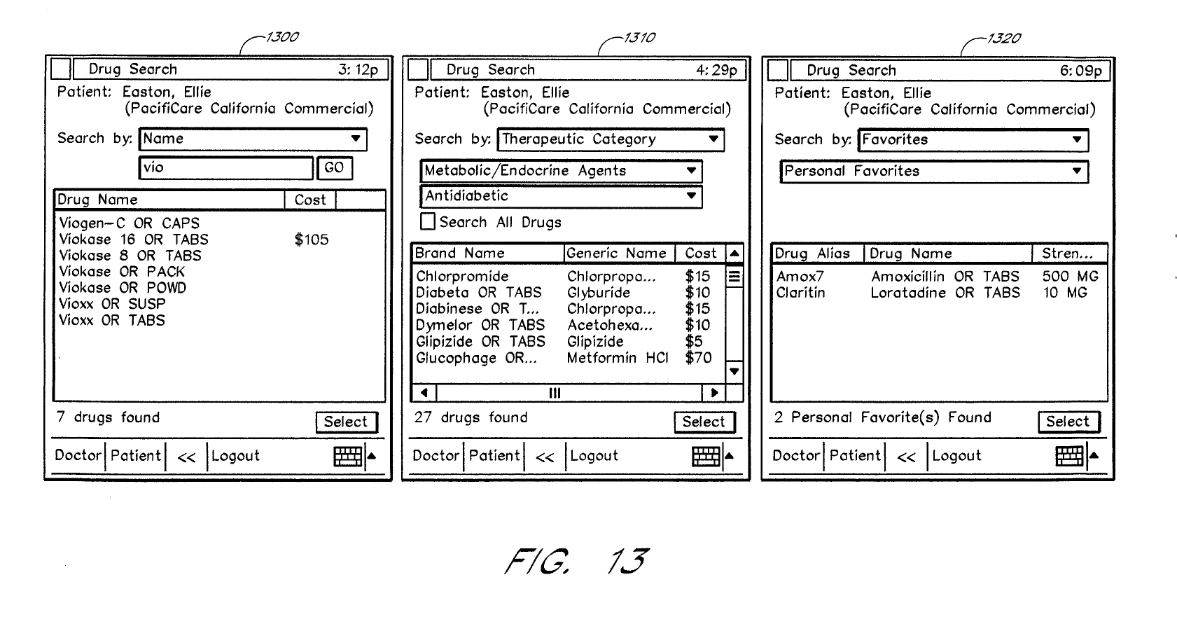

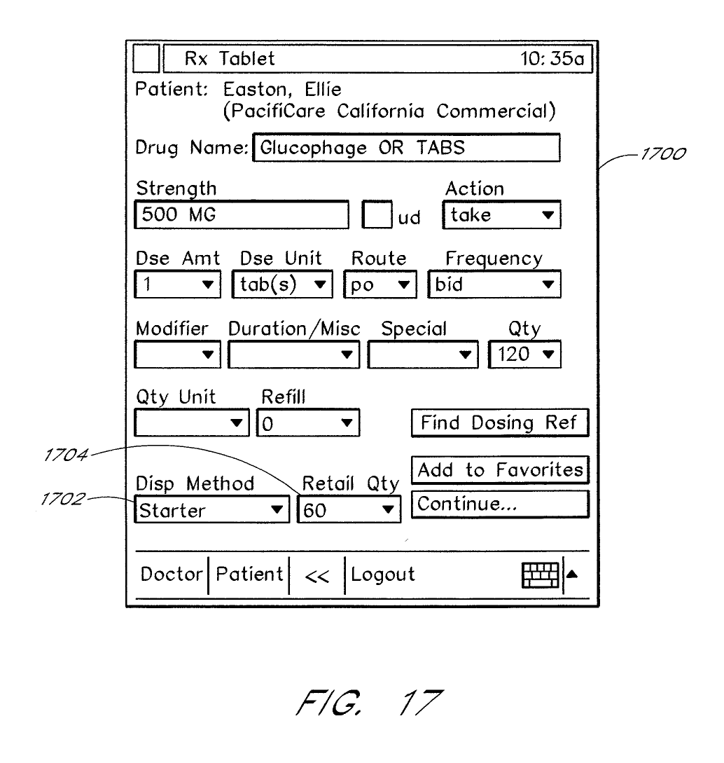

The patient queue screen 300 also includes a “New Rx” button 302, a “Rx History” button 304, and a “Allergy/Misc” button 306. By highlighting a patient name on the patient list and hitting the “New Rx” button 302, the doctor can proceed to another screen to write a new prescription for the selected patient. In one embodiment, the doctor proceeds to one of the drug search screens of FIG. 13. In another embodiment, the doctor proceeds to the prescription tablet screen of FIG. 17.

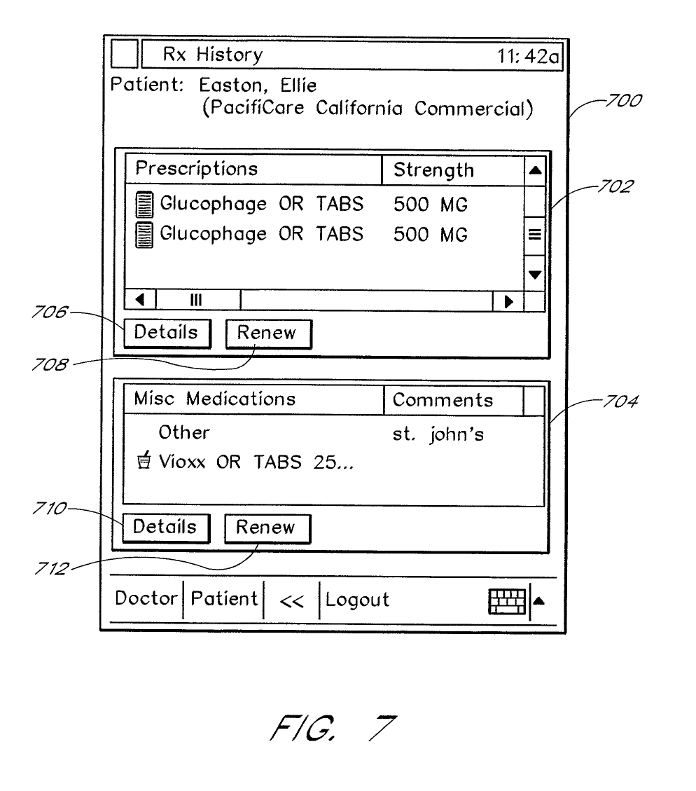

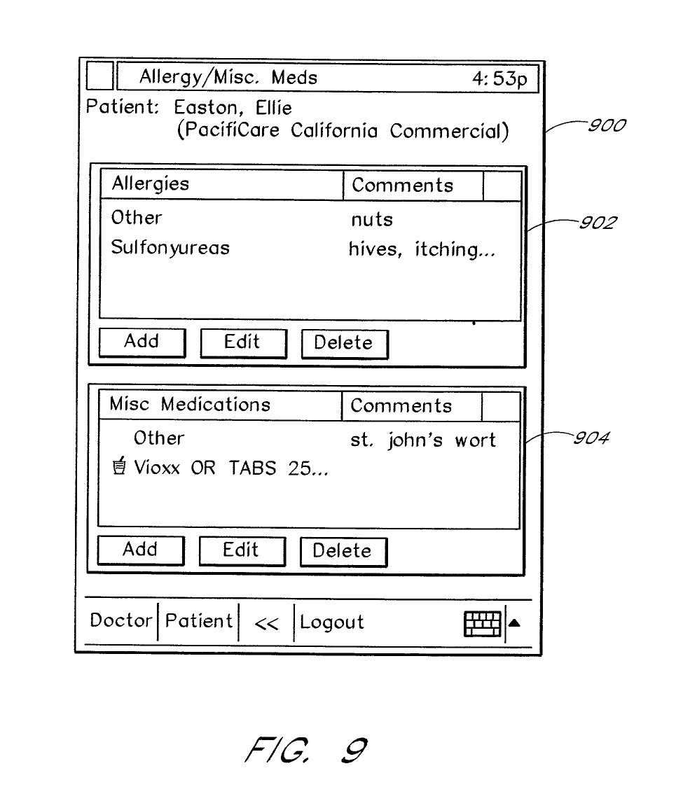

Referring back to FIG. 3, by highlighting a patient name on the patient list and hitting the “Rx History” button 304, the doctor proceeds to a prescription history screen (as shown in FIG. 7) to view the patient's prescription history. By highlighting a patient name on the patient list and hitting the “Allergy/Misc” button 306, the doctor proceeds to an allergy/miscellaneous medications screen (as shown in FIG. 9) to view the patient's allergies and miscellaneous medications or treatments not prescribed by the present doctor.

Referring back to FIG. 3, in another embodiment, a “detail” button (not shown) is also provided. Hitting the detail button allows the doctor to proceed to a detail screen with additional patient information, such as patient's weight, height, address, previous billing and payment information, health insurance co-pay amount, medical history, medical test results, family medical history, and so forth. Such information is typically downloaded from the local server 116 during the synchronization process, but can also be entered by the doctor using the point-of-care device 112 upon interviewing the patient.

If a patient has multiple health plans and multiple doctors, each doctor may access all of the patient's medical history, including treatment by the other doctors, and all of the health plan data and PBM data with each health plan. Because the doctor side components have access to the health plan databases 104 and PBM databases 106 for the multiple health plans, data from other doctors is available via the point-of-care device 112.

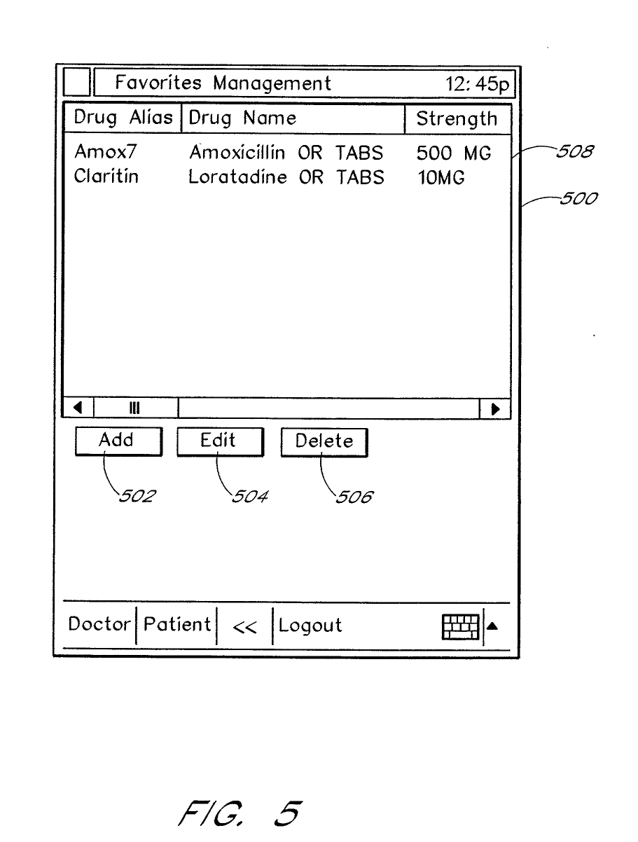

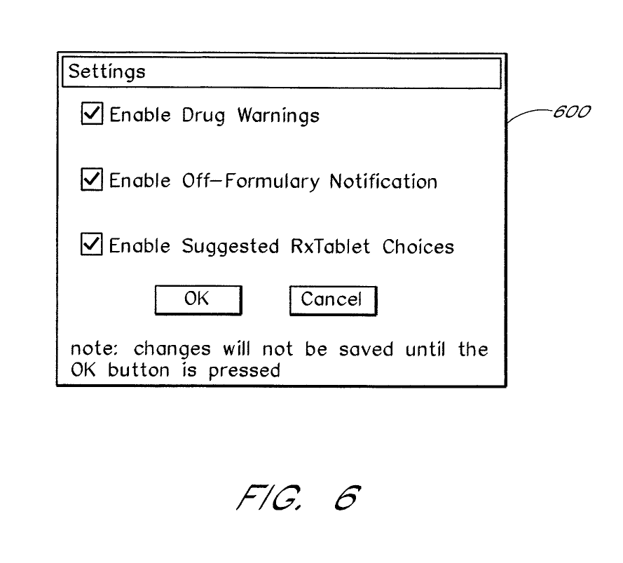

FIG. 4 illustrates one embodiment of a patient queue screen 300 with a popped-up portion 402. The portion 402 is displayed on the PDA 112 when the “Doctor” selection 206 is hit. The portion includes a “Select a Printer” command, a “Change a Password” command, a “Settings” command, a “Sync” command, a “Favorites” command, and a “Patient Queue” command. When one of the commands is selected, the PDA 112 navigates to a particular screen. For example, when the “Favorites” command is selected, the PDA 112 navigates to a favorites management screen of FIG. 5. When the “Settings” command is selected, the PDA 112 navigates to settings screen of FIG. 6.

In some embodiments, when a command is selected, the PDA 112 does not navigate to a separate screen. For example, in one embodiment, when the “Sync” command is selected, the PDA 112 performs synchronization without entering a separate screen. In one embodiment, when the “Select a Printer” command is selected, another portion is popped up on the current screen, prompting the doctor to select from a list of printers.

In one embodiment, with the exception of “Select a Printer” and “Sync”, the selection of any of the other commands will cause the doctor to lose all patient data that has been entered for any case currently open. Therefore, a warning preferably appears in the following form: “Leaving patient—uncompleted/unsent prescriptions will be abandoned.” The doctor may then choose “OK” or “Cancel” as desired.

The “Sync” command activates the PDA's synchronization process with the local server 116. Synchronization is used to retrieve the daily patient schedule and corresponding prescribing history for the day's scheduled patients. This task is preferably automatically performed when a doctor logins in. A typical synchronization process may take several minutes. In one embodiment, the PDA 112 automatically synchronizes with the local server 116 every time a prescription is submitted or printed in order to capture any changes to the day's schedule, for example the adding or removing of scheduled patient visits.

FIG. 5 illustrates one embodiment of a “Favorites Management” screen 500. Some doctors have favorite medications or treatments that they prescribe for certain situations. To facilitate the management of favorite prescriptions, the system allows the doctor to create and to use a list of “Favorites”. The favorites are typically drugs which the doctor prescribes with high frequency, are effective, useful or affordable, or have any quality which the doctor deems appropriate for a “Favorite” drug. A “Favorite” drug need not be a drug that the doctor is personally fond of. It can simply be a drug that has been frequently prescribed by the doctor. In another embodiment, a “Favorite” drug can be a drug that the doctor's medical practice office or group considers appropriate or prescribes with high frequency. A doctor may also have access to multiple favorite lists, for example a favorite list of cold medicines, a favorite list of heart medicines, a favorite list of another doctor in the medical practice office or group, and so forth.

As shown in FIG. 5, a doctor can use the “Add” button 502 to add a favorite prescription. A doctor can also highlight a prescription in the favorite prescriptions list 508, and then use the “Edit” button 504 or the “Delete” button 506 to edit or delete a favorite prescription. When the “Edit” button 504 is selected, the doctor can edit the specifics of a favorite prescription, such as its dosage strength, drug alias, and so forth.

In one embodiment, the doctor double-clicks a favorite prescription in the list 508 to select the prescription. In another embodiment, the screen 500 includes an additional “select” button. The doctor can hit the “select” button to select a favorite prescription. In yet another embodiment, the screen 500 includes a “submit” button. The doctor can hit the “submit” button to submit a favorite prescription to the local server 116 as a completed prescription for the patient.

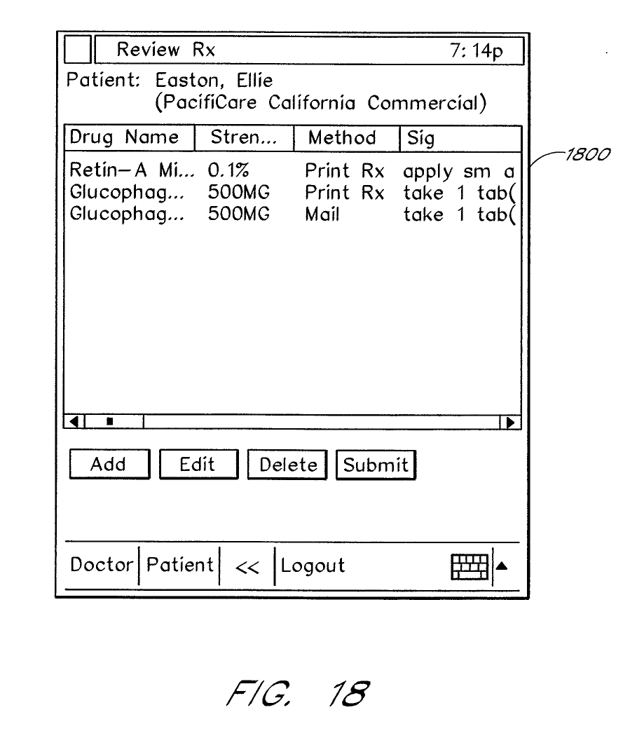

After a favorite prescription is selected, the point-of-care device 112 navigates to the screen shown in FIG. 17, where the doctor may edit the prescription. In another embodiment, after a favorite prescription is selected, the point-of-care device 112 navigates to the screen shown in FIG. 18.

In one embodiment, a prescription can include a package of drugs or treatments. For example, a favorite prescription for congestive heart failure may consist of furosemide, digoxin, and captopril. A prescription as described below in connection with FIG. 13 and FIG. 17 may be a package of medications or treatments.

FIG. 6 illustrates one embodiment of a “Settings” screen 600. The settings screen 600 enables the doctor to customize the PDA application with respect to selected functions to suit the doctor's preferences. A checkmark signifies that the specific function is activated and will apply during use. The settings should be selected prior to or after a prescribing session.

One of the editable settings is “Enable Drug Warnings”. When activated, the point-of-care device 112 presents a warning message when the doctor selects a drug that is likely to cause drug-to-drug interactions for the patient, drug/allergy interactions, or is a duplicate therapy. In one embodiment, this setting is set to an enabled default value to present warnings. In one embodiment, in order to always present warnings, this setting is always set to enabled and cannot be turned off by a doctor.

When the doctor selects a drug, the point-of-care device 112 checks the selection against other drugs of the current prescription, drugs in prescription history and recently taken by the patient, and miscellaneous medications recently taken by the patient. The point-of-care device 112 checks the prescriptions against a stored collection of undesirable drug-to-drug interactions.

The point-of-care device 112 presents a warning to the doctor when the doctor selects a drug that may cause undesirable interactions with another drug currently prescribed to the patient, currently taken by the patient as miscellaneous medication, or in the prescription history of the patient and recently taken by the patient. The drug interaction warnings may also include an analysis of the patient's family history. For example, if a certain drug is not suggested for those with high risk of stroke, and a patient has a family history of stroke, then a warning may be presented to the doctor. The drug interaction warnings may also include an analysis of a patient's living habits, such as whether the patient smokes, drinks, or eats a certain type of diet.

Many drugs have very similar effects as one another, and may result in duplicate therapy if both are taken simultaneously. For example, prescriptions of amoxicillin and penicilin are both used for general antibiotic purposes. The point-of-care device presents a warning to the doctor when the doctor selects a drug that may cause duplication with another drug that is currently prescribed to the patient, currently taken by the patient as miscellaneous medication, or is in the prescription history of the patient and has been recently taken by the patient. Thus, when choosing a drug, the doctor will be forewarned and may alter the prescription based on the warning.

When the doctor selects a drug, the point-of-care device 112 also checks the allergies listed for the patient against a stored collection of drug-allergy interactions, and presents a warning to the doctor when the drug may trigger an allergy of the patient.

When the setting “Enable Suggested RxTablet Choices” is selected, the point-of-care device 112 activates an automatic filtering of the prescription writing choices, to be described below in connection with FIG. 17. When the automatic filing setting is disabled, all of the prescription writing choices are made available to the doctor without filtering.

FIG. 7 is one embodiment of a “Rx History” screen 700. The upper portion 702 displays prescriptions for the displayed patient that have been prescribed within a time period, for example within the last 6 months. The upper portion 702 also includes a “Details” button 706 and a “Renew” button 708. By highlighting a displayed prescription and hitting the details button 706, the doctor can view details of the prescription. By highlighting a displayed prescription and hitting the renew button 708, the doctor can quickly renew the prescription.

In a preferred embodiment, the displayed prescriptions in the upper portion 702 of FIG. 7 include previous prescriptions written by other doctors of the patient. In another embodiment, the previous prescriptions written by the other doctors are displayed in the lower portion 704 as miscellaneous medications. The previous prescriptions of other doctors have been downloaded to the local server 116 from the health plan database 104 and the PBM database 106. If the prescription data of other doctors are not available from the health plan database 104 and the PBM database 106, they can be entered manually on the local server 116 or on the point-of-care device 112.

Because of legal regulations and privacy reasons, previous prescriptions of AIDS-related medications and specialized alcohol and substance abuse drugs are preferably not displayed unless the particular doctor has prescribed the drug to this patient. However drug interaction, allergy and duplication checking may still be performed. This technique may be extended to other privacy-sensitive treatment, such as anti-depression medication or treatment for mental illness.

The lower portion 702 displays miscellaneous medications taken by the patient within a time period. Miscellaneous medications may refer to over-the-counter drugs or herbal supplements the patient has reported taking. In one embodiment, miscellaneous medications may also include prescriptions written by other doctors of the patient. The lower portion 704 also includes a “Details” button 710 and a “Renew” button 712. By highlighting a displayed medication and hitting the “Details” button 710, the doctor can view details of the medication. By highlighting a displayed medication and hitting the “Renew” button 712, the doctor can renew the purchase order or prescription.

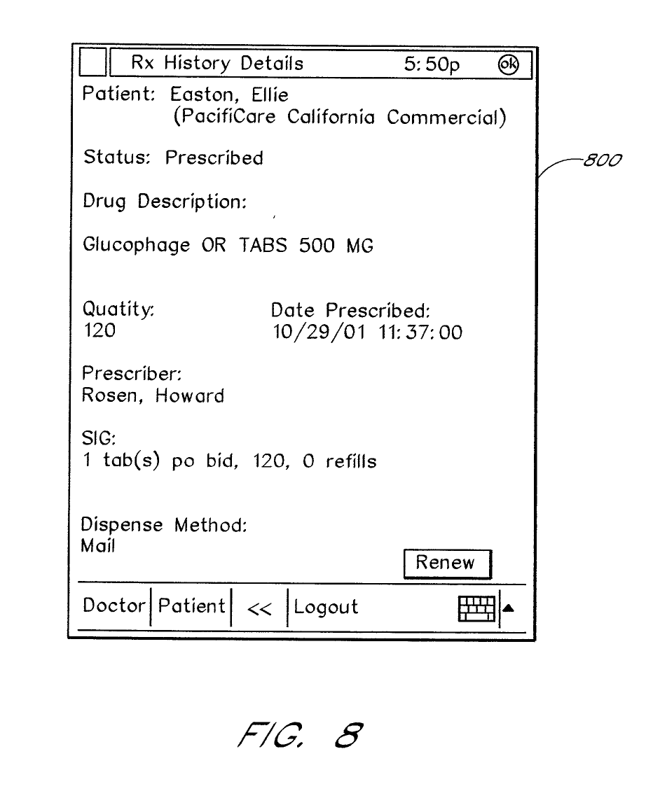

When the doctor hits the “Details” button 706 of FIG. 7, a prescription history details screen 800 as shown in FIG. 8 is displayed. This is a read only screen and cannot be edited. The prescription may also be renewed from this screen by hitting the “Renew” button. The point-of-care device 112 then navigates to the “Rx Tablet” screen of FIG. 17.

FIG. 9 illustrates the “Allergy/Misc. Meds” screen 900 which can be used for adding, deleting, and editing allergies or miscellaneous medications. The screen 900 includes an upper portion 902 listing the allergies of the patient and a lower portion 904 listing the miscellaneous medications or treatments of the patient.

The allergies listed in FIG. 9 may include reactions to medications which are not typically classified as “allergies”. For example, stomach upset or other side effects may be listed as allergies. The upper portion 902 “Allergy/Misc. Meds” displays all allergies or other reactions including those to medications, foods, insects, animals, plants, perfumes, latex, wool, nutriceuticals, and herbs for the chosen patient.

The screen 900 also allows the doctor to add, edit or delete allergies or miscellaneous medications of the patient using the respective buttons in the upper portion 902 and the lower portion 904. Such information can also be obtained and entered by a nurse. For example, prior to the doctor's session with the patient, a nurse may interview the patient or review a questionnaire filled out by the patient, and enter the patient's allergies or miscellaneous medications using the local server 116 or another point-of-care device 112.

FIG. 10 illustrates one embodiment of a patient allergy/miscellaneous medications screen 900, with a popped-up portion of command list. When the doctor selects the patient command 208, a command list pops up on the screen 900. The command list includes a “History” command, an “Allergy/Misc” command, a “New Rx” command, and a “Review Rx” command.

When the “History” command is selected, the PDA 112 proceeds to the screen of FIG. 7 to display the prescription history of the patient. When the “Allergy/Misc” command is selected, the PDA 112 proceeds to the screen of FIG. 9 to display the allergies and miscellaneous medications of the patient. When the “New Rx” command is selected, the PDA 112 proceeds to one of the screens of FIG. 13 or the screen of FIG. 17 to allow the doctor to write a new prescription for the patient. When the “Review Rx” command is selected, the PDA 112 proceeds to the screen of FIG. 18 to display the prescriptions that the doctor has written for the patient in the present session.

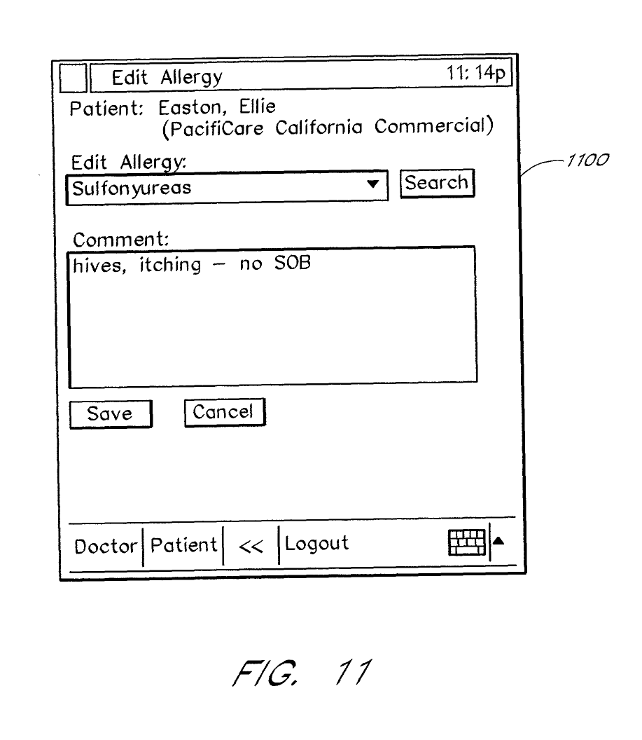

FIG. 11 illustrates one embodiment of a patient allergy edit screen 1100 of a point-of-care device. When the “Edit” button in the upper portion 902 of FIG. 9 is selected, the PDA 112 proceeds to the screen 1100 to edit an allergy of the patient. As shown in FIG. 11, the doctor can edit the name or comments of the allergy.

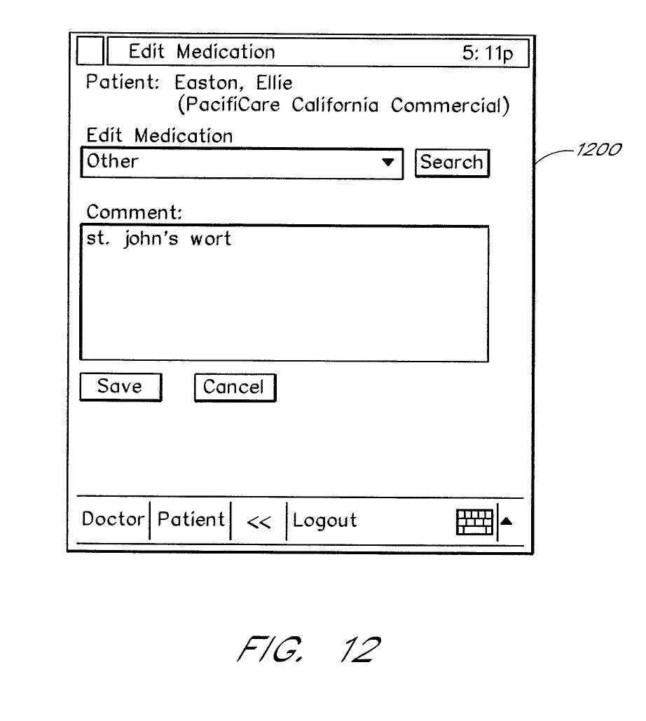

FIG. 12 illustrates one embodiment of a patient miscellaneous medications edit screen 1200 of a point-of-care device. When the “Edit” button in the lower portion 904 of FIG. 9 is selected, the PDA 112 proceeds to the screen 1200 to edit a miscellaneous medication of the patient. As shown in FIG. 12, the doctor can edit the name or comments of the miscellaneous medication or treatment.

FIG. 13 illustrates three drug search screens of one embodiment of a point-of-care device. The screen 1300 displays a list of drugs searched by name. The screen 1310 displays a list of drugs searched by therapeutic category. The screen 1320 displays a list of drugs searched by favorites. For each of the displayed drugs, the screens 1300, 1310 and 1320 may also display other information, such as whether the drug is a generic or brand name drug, whether the drug is in the formulary of the patient's PBM, whether the drug is recently added to or removed from the formulary, whether the drug is covered by the patient's health plan, whether the drug is a newly available drug, and so forth.

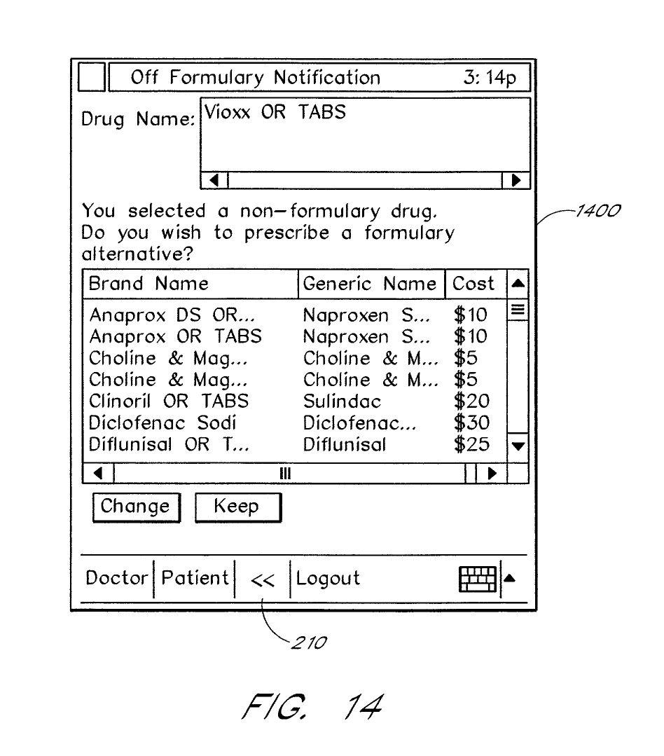

FIG. 14 illustrates one embodiment of an off-formulary warning screen 1400. When the doctor identifies a drug from one of the screens of FIG. 13 or from the screen of FIG. 17, the PDA 112 checks whether the drug is in the formulary of the PBM of the patient. If it is not within the formulary, then the PDA 112 finds the alternative drugs that are within the formulary, and presents a warning message and the alternative drugs to the doctor in screen 1400. In one embodiment, the PDA 112 selects as alternative drugs all drugs within the formulary that are within the same category as identified drug, for example within the same category as treating digestive heart failure. This screen may also indicate the cost to the patient of the drug and the cost of its alternatives. In this way the doctor and the patient can make an informed decision about which drug to use.

The doctor can use the “Keep” button to keep the off-formulary drug as the prescription. To change to a formulary alternative in the list, the doctor highlights an alternative drug in the alternative list of screen 1400, and selects the “Change” button to change the prescription to the highlighted alternative. The doctor can also use the back selection 210 to return to the previous screen in FIG. 13 or FIG. 17 to identify another drug.

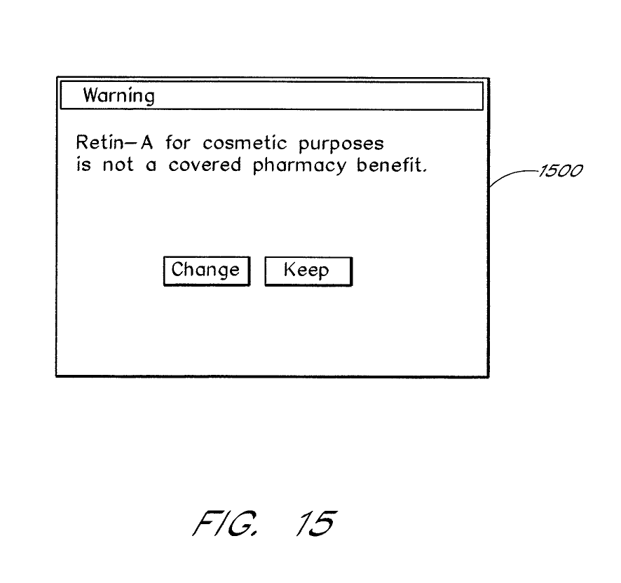

FIG. 15 illustrates one embodiment of a coverage warning screen 1500. When the doctor identifies a drug from one of the screens of FIG. 13 or from the screen of FIG. 17, the PDA 112 checks whether the drug is a covered pharmacy benefit for the patient's health plan and PBM. If the drug is not a covered pharmacy benefit, then the PDA 112 displays a warning message to the doctor. For example, as shown in FIG. 15, although RETIN-A may be permitted by the health plan if used for medical purposes, it is not a covered pharmacy benefit for cosmetic purposes. The doctor selects the “Keep” button to keep the prescription or selects the “Change” button to go back to the previous screen. The warning screen 1500 can be a separate screen as shown in FIG. 15. It can also be a warning window displayed on one of the screens 1300, 1310, 1320 or 1700.

In one embodiment, when the doctor identifies a medication or treatment that requires prior authorization by the patient's health plan provider, for example, a drug that is off-formulary or is not a covered pharmacy benefit, the point-of-care device 112 warns the doctor that prior authorization is required. The point-of-care device 112 prompts the doctor to indicate whether to keep the drug as part of a prescription for the patient. In one arrangement, the point-of-care device 112 prompts the doctor to enter one or more authorization reasons or select from a list of authorization reasons.

After the doctor submits the drug as part of a prescription and synchronizes the point-of-care device 112 with the local server 116, the local server 116 prints out a prior authorization form on the printer 118. The prior authorization form may include the authorization reasons entered or selected by the doctor. The patient sends the printed prior authorization form to the health plan provider. In another arrangement, the local server 116 directly sends a prior authorization to the health plan database 104 for authorization.

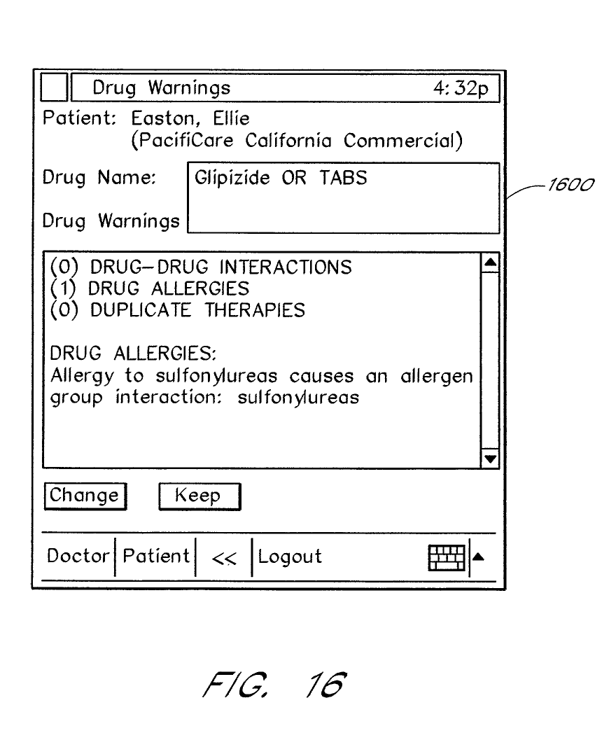

FIG. 16 illustrates one embodiment of a drug interaction/allergy/duplication warning screen 1600. When the doctor identifies a drug from one of the screens of FIG. 13 or from the screen of FIG. 17, the PDA 112 checks whether the drug may cause drug-to-drug interactions with other prescriptions or miscellaneous medication for the patient, whether the drug may cause drug/allergy interactions with allergies of the patient, and whether the drug may cause duplication with other prescriptions or miscellaneous medication for the patient.

If the PDA 112 finds any interaction or duplication, the PDA 112 displays a warning to the doctor in screen 1600. The doctor selects the “Keep” button to keep the prescription or selects the “Change” button to go back to the previous screen.

FIG. 17 illustrates one embodiment of a prescription tablet screen 1700. This screen allows the doctor to write a prescription. Some of the fields of a prescription, such as its strength, action, dosage amount, and so forth, may be populated with a drug manufacturer's recommendations as default values. A doctor can then edit these fields to change the values.

In one embodiment, the doctor may select one of the following values for the dispense method field 1702: “Mail,” “Starter,” “Print Rx,” and “Record Only.” The doctor selects the “Mail” method when the prescription is to be filed by a mail service pharmacy. An email, electronic record or fax of the prescription is then sent to the mail service pharmacy from the point-of-care device 112 or from the local server 116 synchronized with the point-of-care device 112. The doctor selects the “Starter” method when the patient is to purchase a retail “starter” portion of the prescription with a retail quantity 1704 and to fill the mail portion with a mail order pharmacy. The doctor selects the “Print Rx” method to print out the prescription for the patient to physically take to or mail to a pharmacy. The doctor selects the “Record only” method to print out a chart copy only.

If the “Suggested Rx Table Choices” setting is enabled, then the point-of-care device 112 filters the selection choices for a given prescription field in screen 1700 to those recommended by the pharmacopoeia. For example, for a drug that is typically only taken orally, the point-of-care device 112 automatically filters choices to those recommended by the pharmacopoeia so that only the choice “orally” can be selected. If the automatic filtering setting is disabled, then the point-of-care device 112 presents all of the choices to the doctor. This may be of use when a drug is being prescribed for a non-typical reason or disease or if the patient is non-typical in any way. In another embodiment, the point-of-care device 112 makes available all the choices to the doctor, with the recommended (i.e., typical) choices displayed in highlight.

FIG. 18 illustrates one embodiment of a prescription review screen 1800. The “Review Rx” screen 1800 allows the doctor to verify the list of prescriptions he or she has written for the patient in the current session. The doctor can use the “Add,” “Edit” and “Delete” buttons to add, edit or delete a prescription in the prescription list. When the doctor confirms that the prescriptions are correct and complete, the doctor hits the “Submit” button to submit the prescriptions. The point-of-care device 112 synchronizes with the local server 116 at this time or at the end of the day to send the prescription submission to the local server 116. Paper copies such as a retail copy, a mail receipt and a chart copy may be printed on the printer 118. The point-of-care device 112 then navigates to the “Patient Queue” screen 300 of FIG. 3 so that the doctor can review information and write prescriptions for the next patient.

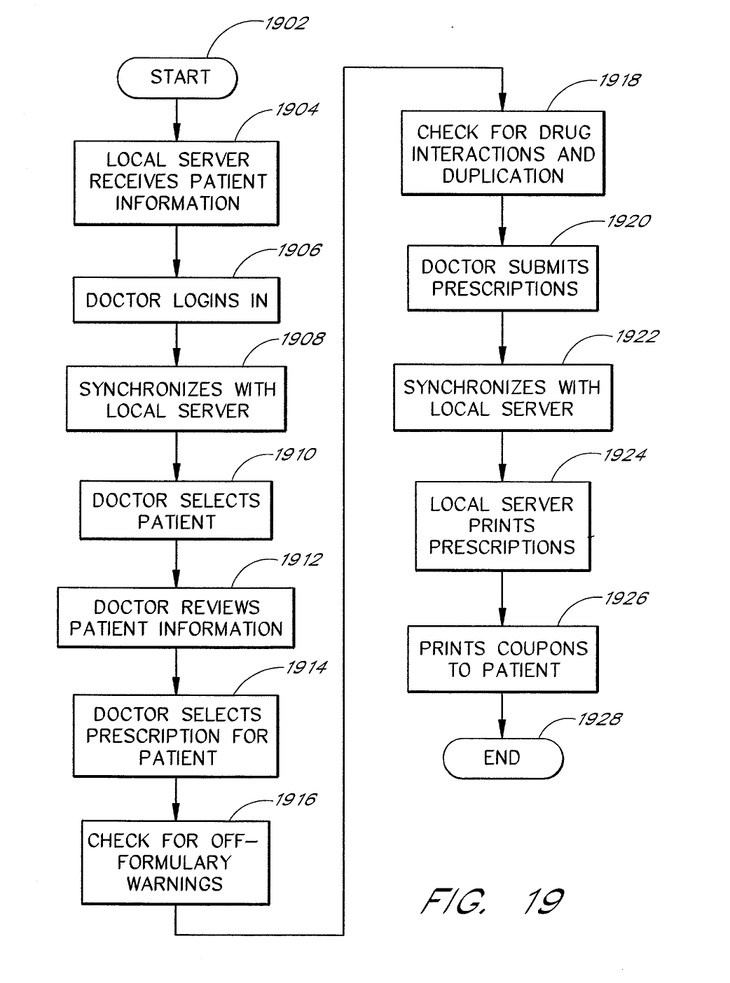

FIG. 19 is a flowchart illustrating an overview of one embodiment of a process using the disclosed system. Referring to FIG. 19, the process starts at a start block 1902 and proceeds to a block 1904, where the local server 116 receives patient information such as patient's demographic data, symptoms and medical history. The patient information may be received from the employer database 102, the health plan database 104, the PBM database 106, the PPM database 120, or manually entered into the local server 116 by an office clerk, nurse, doctor or the patient.

From the block 1904, the process proceeds to a block 1906, where a doctor logins into a point-of-care device 112 connected by wire or wirelessly to the local server 116. The process proceeds to a block 1908, where the point-of-care device 112 synchronizes with the local server 116 to receive data from the local server 116. The point-of-care device 112 receives data such as a list of the current day's patients scheduled to visit the doctor, and their respective patient information. The point-of-care device 112 may also receive other information, such as drug price updates, health plan rule changes, and changes to drug interaction, allergy and duplication warning rules.

Still referring to FIG. 19, the process proceeds to a block 1910, where the doctor reviews the patient queue displayed on the point-of-care device 112, and selects the visiting patient. The process proceeds to a block 1912, where the doctor reviews the patient's information on the point-of-care device 112. The doctor may also question the patient and enter additional patient information on the point-of-care device 112. The process proceeds to a block 1914, where the doctor enters a prescription for the patient.

The process proceeds from the block 1914 to a block 1916, where the point-of-care device 112 determines whether the selected prescription is within the formulary of the health plan of the patient. If the prescription is off formulary, the point-of-care device 112 displays a warning to the doctor, and permits the doctor to change to another prescription. The point-of-care device 112 also determines whether the prescription is a benefit covered by the patient's health plan. If not, the point-of-care device 112 displays a warning to the doctor, and permits the doctor to change to another prescription.

The process proceeds to a block 1918, where the point-of-care device 112 determines whether the selected prescription may cause drug interactions, allergies or duplications. If such a risk is detected, the point-of-care device 112 displays a warning to the doctor, and permits the doctor to change to another prescription.

Still referring to FIG. 19, the process proceeds from the block 1918 to a block 1920, where the doctor completes writing prescriptions for the patient and submits the prescriptions as final results to the point-of-care device 112. The process proceeds to a block 1922, where the point-of-care device 112 synchronizes with the local server 116 and uploads the prescriptions to the local server 116. The local server 116 also receives from the point-of-care device 112 the additional patient information entered by the doctor.

The process proceeds to a block 1924, where the local server 116 prints the received prescriptions on a printer, so that the patient can take the prescriptions to a pharmacy. In another embodiment, the local server 116 sends the prescriptions to a mail order pharmacy. In yet another embodiment, the local server 116 sends the prescriptions electronically to a pharmacy, so that the pharmacy fills the prescription and waits for the patient to pick up the drugs. The local server 116 may also update a favorite prescriptions list of the doctor.

Unlike more traditional prescription writing and delivery systems, all of the appropriate formulary, PBM and allergy/interaction checking is performed locally to the point-of-care device itself. This produces a prescription which is much less likely to require a follow-up call or other confirmation on the part of the pharmacist or other pharmacy representative. By producing a prescription which is less likely to require any additional confirmation or instruction, the role of the pharmacist is simplified, and the number of confirming calls to a doctor's office may be reduced significantly.

This may be particularly advantageous when dealing with a pharmacy with which the patient may never have conducted business in the past. For instance, if a patient is travelling or otherwise away from their normal health care provider, but is being treated by a doctor covered under the patient's health plan, it is now possible for the doctor to perform all of the appropriate formulary, coverage and interaction checking such that the pharmacist need not. Because the local pharmacist may not have access to the complete history of the patient, this allows the prescription to be filled with a higher degree of confidence, even though the local pharmacist may never have met the patient before, or have any access to the medical history of the patient directly. The appropriate access was provided at the doctor's office through the point-of-care device, thereby protecting the patient without increasing the workload on the pharmacy required to handle a one-time or non-local patient.

This technique is also of benefit for mail-order prescription filling. Because such a large fraction of dispensed prescriptions are for chronic medication, it is often possible to predict well in advance when a given prescription will be needed, and the appropriate order filled and shipped via mail order. This simplifies refilling for the patient and the pharmacy. However, taking and confirming mail order prescriptions is often complicated by the fact that mail order pharmacies may not be local to the particular patient or doctor, and may not have direct access to the appropriate databases needed to efficiently carry out the interaction and formulary checking processes described herein. However, if these processes are handled by the doctor via the point-of-care device, the number of confirmations and the amount of data access required by the mail order pharmacy are reduced, resulting in a more streamlined process. This not only simplifies the process for the parties involved, but makes mail order dispensing of medications a much more effective alternative.

As an additional service to the patient, the local server 116 searches the one or more pharmacy databases 110 to find the pharmacy chains or pharmacy stores that have the patient's prescribed drugs in inventory, and then prints out the pharmacy list to the patient. In one arrangement, the local server 116 finds the pharmacy stores located near the patient's address, and prints out the list to the patient. In another arrangement, the local server 116 prints out to the patient a list of favorite pharmacies. The favorite pharmacies can be the pharmacies most highly rated by patients in surveys, the pharmacies most frequently used by patients for prescriptions, and pharmacies that are selected using other factors. In yet another arrangement, based on the patient's claim history data, the local server 116 prints out to the patient a list of pharmacies most recently used by the patient.

Any of the above-described arrangements can be combined to produce a pharmacy list. For example, the local server 116 can produce a list of pharmacy stores that have the patient's prescribed drugs in inventory and are near the patient's address. The pharmacies on the list can be sorted by their listed prices for the patient's prescribed drugs.

In one embodiment, the local server 116 displays the pharmacy list to the patient and prompts the patient to select one of the pharmacies from the list. The patient may also select another pharmacy not on the list. The patient selects the pharmacy using the local server 116 directly or through a nurse operating the local server 116. The local server 116 then sends the patient's prescription request electronically to the selected pharmacy.

The process proceeds to a block 1926, where the local server 116 selects and prints any applicable coupons for the patient. In one embodiment, the local server 116 is connected to a coupon database via the doctor's office network 122, an Intranet or the Internet. The coupon database stores records of coupons, with each coupon associated with one or more medical conditions or prescriptions. For example, a coupon for a maternity store may be associated with an amniocentesis test in the coupon database, and a coupon for a new medication for lowering the blood glucose in patients with type II diabetes may be associated with a prescription for Glucophage. A marketing agency, such as an association for retail stores or the marketing department of a sales organization, is typically responsible for updating the coupon records in the coupon database.

Coupons are typically discounts on purchases of products or services, but can also be advertisements for products, services or clinical studies. A coupon for a clinical study may include a printed enrollment number to facilitate the patient's enrollment. The local server 116 searches the coupon database for coupons associated with the patient's prescriptions or medical conditions. For example, if the prescriptions for the patient includes performing an amniocentesis, then the local server 116 finds and prints out coupons for a maternity store to present to the patient. In one embodiment, the local server 116 also performs a drug interaction/allergy/duplication check, to ensure that the coupons are not for drugs that will cause interaction or duplication with the prescriptions.

Such “permission based marketing” allows the patient to take advantage of offers which are based upon his or her medical condition, but does not require disclosure of the patient's information to third party marketing agencies. This protects the confidentiality of the patient while still providing a potential benefit to both patient and the organizations marketing their goods or services. From the block 1926, the process then proceeds to an end block 1928.

Although the process as described above and shown in FIG. 19 is considered in a linear fashion, it will be apparent to those of skill in the art that the outcome of certain blocks in the process will lead to repeating other steps, or even jumping out of the flow entirely. For example, if in block 1916, any off-formulary warnings are found, the sequence described above and shown in FIGS. 14 and 15 will be followed before proceeding. Similarly, if a drug-drug interaction is found in block 1918, the appropriate process described above will be followed. The results of such operations may result in the doctor jumping back to an earlier portion of the illustrated flow (e.g., selecting a new prescription for the patient by returning to block 1914), or taking appropriate actions such that the process may move forward to the step of submitting the prescription (block 1920).

Similarly, as described herein, once the prescription is submitted and the patient receives his receipt, the order may be sent out as described above in a manner appropriate to the dispensing technique selected on the point-of-care device. For example, if a mail-order prescription has been selected by the doctor in block 1914, the appropriate order and notification is sent to the mail order company and the prescription is filled and sent. If circumstances where the prescription is being filled by a local pharmacy and there is a co-payment or other transaction which must take place locally, these processes can be handled as is known in the art.

In particular, it should be noted that the system described herein can be used even in circumstances in which the patient may not be a member of any health plan or other coverage accepted by the particular doctor or health-care practitioner. In such cases, an ordinary payment via cash or other up-front payment may be made, and the remainder of the operation of the system may proceed accordingly. Since there may be no particular formulary or other coverage associated with this particular patient, the operation of certain functions will be altered, however, the majority of the functions, such as drug interactions, allergies, and pharmacy choice may all be carried out in the same manner as described above.

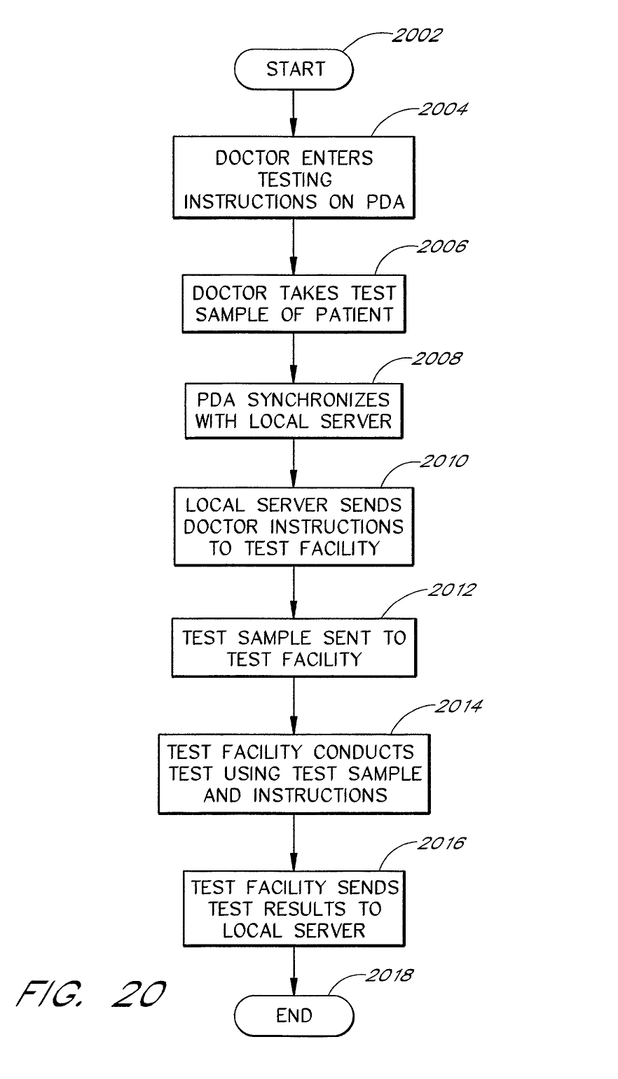

The disclosed system can also improve the communication between doctors and test facilities, and reduce the redundant data entry at test facilities. FIG. 20 is a flowchart illustrating one embodiment of a process of conducting medical tests for a patient. As shown in FIG. 20, a start block 2002 proceeds to a block 2004, where the doctor determines that a medical test is needed, and enters testing instructions on a point-of-care device 112. Some tests may be taken at the doctor's office by the doctor or a nurse. Other tests may be taken at a remote location such as a hospital radiology department or a medical laboratory. Where the patient needs to go to the test facility for the test, a paper copy of a tracking label with a test tracking number may be printed, so that the patient can take the copy to the test facility for identification purpose. The doctor enters on the point-of-care device 112 testing instructions to be read by the test facility or by the nurse. The doctor may also enter instructions on the point-of-care device 112 for the patient, such as “do not eat for 12 hours prior to the test” or “avoid operating heavy machinery or driving a vehicle for 3 hours after the test,” and print out a paper copy for the patient.

If the test requires the doctor to take a test sample of the patient, then the process proceeds to an optional block 2006, when the doctor takes a test sample of the patient. The process then proceeds from the block 2006 to a block 2008. If the test does not require the doctor to take a sample, the doctor may simply direct the patient to go to a test facility such as a hospital radiology department for the test. The process then proceeds from the block 2004 to the block 2008.

At the block 2008, the doctor synchronizes the point-of-care device 112 with the local server 116. As a result the testing instructions entered by the doctor is loaded to the local server 116. Additional information, such as the patient's name, the doctor's name, the name of the medical test facility and billing data may accompany the testing instructions. The process proceeds to a block 2010, where the local server 116 sends the testing instructions to the test facility. If the doctor has taken a test sample of the patient, then the process proceeds to an optional block 2012, where the test sample is sent from the doctor's office to the test facility. The process then proceeds from the block 2012 to a block 2014. Otherwise the process proceeds from the block 2010 to the block 2014.

Still referring to FIG. 20, at the block 2014, the test facility conducts the medical test according to received testing instructions. If a test sample is received, then the test facility conducts the test on the test sample. In one embodiment, the test facility also receives patient payment information from the local server 116. The test facility may receive the patient's insurance information from the local server 116, from the health plan database 104 or from the PBM database 106.

The process proceeds to a block 2016, where the test facility sends the test results to the local server 116. If the test results indicate a serious condition requiring immediate attention, the test facility sends a warning message regarding the test to the local server 116. In one embodiment, the warning message is displayed when a user logins into the local server 116. In another embodiment, the warning message is displayed when the doctor who ordered the test logins into a point-of-care device 112 and synchronizes with the local server 116. In yet another embodiment, the warning message is sent via email to the patient, the doctor, or other health care workers. The process proceeds from the block 2016 to an end block 2018.

The disclosed system also allows the doctor to refer the patient to another doctor such as a specialist, and allows for the easy sharing of patient information among the doctors. For example, during an office visit with a patient, the doctor selects a specialist from a list of specialists on the point-of-care device 112. The doctor then synchronizes the point-of-care device 112 with the local server 116. The local server 116 sends a referral notice to the specialist, informing the specialist that the patient has been referred. The local server116 may also send the patient information to be specialist, such as the patient's identification code, medical history, symptoms, current prescriptions, billing information, and so forth. In a preferred embodiment, the specialist's office also includes a local server and a point-of-care device, and the specialist's local server receives the referral notice and optionally the patient information from the local server 116 of the referring doctor.

Noncompliance with prescription is a common problem that causes poorer health and increased pain for patients. Noncompliance may be caused by purposeful actions such as fraud, or caused by human error or failed memory. Additional embodiments of the disclosed system allow for the verification that a patient is timely filling and refilling a prescription, allowing the physician, the health plan provider or the PBM to verify compliance.

For example, when a patient fills or refills a prescription at a pharmacy, the information is entered into the pharmacy database 110. A server 124 compares this information with the prescription of the patient. If the prescription is not filled or refilled at the appropriate time, for example if a prescription for 30 days has not be refilled after 40 days, or a prescription for 30 days has been refilled after 5 days, the server 124 sends a warning message to the local server 116. The doctor's office may contact the patient to remind the patient to refill prescriptions. The doctor who wrote the prescription may receive a warning message when he or she logins into the point-of-care device 112 and synchronizes with the local server 116.

The doctor, health plan provider or pharmacy can also send reminders to the patient. For example, when a doctor submits a prescription using the point-of-care device 112, the doctor selects a “daily telephone reminder” choice for the prescription using the point-of-care device 112. After the point-of-care device 112 is synchronized with the local server 116, the local server 116 automatically calls the patient every day reminding the patient to take the prescription. The local server 116 can also send an email or a fax to the patient, or prompt a nurse to contact the patient. The local server 116 can maintain a record of attempts to remind the patient. The local server 116 can also send periodic reminders to the patient to refill the prescription. Using the patient prescription data stored in the pharmacy database 110 or the health plan database 104, a pharmacy or a health plan provider can also send the reminders.

The disclosed system also allows for factoring the revenue stream associated with a particular doctor or office. A health plan provider can link the salary and payment information for its doctors to the patient visit records that are generated through the use of the point-of-care devices and local servers. For instance, using the data generated with the point-of-care devices and local servers, a health plan provider can identify how many patients visited a doctor over a time period.

The patient visit data can be used by the health plan provider to verify whether the appropriate quotas were being met by the doctors, and payments to the doctor's office can be made accordingly to the payment arrangements between the health plan provider and the doctor's office. Because the patient visit data is tracked automatically and readily available, the doctor can opt to defer payment for particular work until a later time in exchange for consideration, such as interest, from the health plan provider.

For instance, if the normal arrangement between a doctor's office and a health plan provider is to receive a fixed fee per patient visit completed, the number of patient visits can be collected from the point-of-care devices 112 and the local server 116 in the doctor's office. If the health plan provider is willing to pay a premium at a later time to delay the making of a payment, the provider can offer the doctor a bonus in exchange for the delay. In one embodiment, during a session with a patient, a doctor can select on his or her point-of-care device 112 whether to either accrue the receivable immediately at one rate, or to accrue it at a later date at a higher per visit rate. In another embodiment, a doctor or administrator selects on the local server 116 whether to accrue the receivable for patients immediately or at a later time.

Multiple rates for various deferment schedules may be established. This can be of especial benefit to a doctor who has a particularly busy month, for example. After the doctor's office has reached a certain revenue goal for the month, the doctor may choose to defer the receipt of payment for any remaining patients seen during the month, in order to receive the payments plus bonus payments at a later time.

The health plan provider meanwhile gains the opportunity to reduce its payable in a particular month, and may then use that money to cover its own expenses in advance. By using such a system, the receivable schedule of individual docotor's offices may be tailored in real time to the needs of each office, while providing a benefit to the health plan provider of increased use of its financial reserves.

The various embodiments of the medical service and prescription management system described above thus provide a means to provide more efficient preparation and selection of prescriptions by a doctor, as well as means to collect and analyze information. By using this data to estimate the level of use of various formulary medications, as well as to simplify data entry, the system may allow for more cost effective service to patients, as well as better feedback to pharmaceutical companies and other medical industry organizations. The system also allows for the promotion of products and services to the patients who are likely to need such products and services. It also allows healthcare providers and doctors to negotiate flexible payment arrangements. It allows automated test instructions preparation and communication to test facilities.

Of course, it is to be understood that not necessarily all such objects or advantages may be achieved in accordance with any particular embodiment described herein. Thus, certain embodiments may be configured to operate in a manner that achieves or optimizes one advantage or group of advantages as taught herein without necessarily achieving other objects or advantages as taught herein.

Although systems and methods have been disclosed in the context of certain preferred embodiments and examples, this invention may be embodied in other specific forms without departing from the essential characteristics as described herein. The embodiments described above are to be considered in all respects as illustrative only and not restrictive in any manner. The scope of the invention is indicated by the following claims and their equivalents.

What is claimed is:

1. A method for marketing medical products or services, the method comprising:
loading a medical profile for a patient into a selection module;
loading a set of available marketing offers into the selection module, each of the set of marketing offers comprising a product or service which may be made available to a patient and a target profile;
comparing the target profile of at least one of the set of marketing offers to the medical profile;
selecting one or more of the marketing offers whose target profile matches the medical profile of the patient; and
presenting the selected marketing offers for approval.

2. The method of claim 1 wherein presenting the selected marketing offers comprises displaying the selected offers to a doctor of the patient for approval for the patient.

3. The method of claim 1 wherein presenting the selected marketing offers comprises printing the selected offers at an office of a doctor of the patient.

4. The method of claim 1 wherein the medical profile for the patient comprises demographic data and the target profile information is related to the demographic data of the patient.

5. The method of claim 1 wherein the medical profile for the patient comprises prescription data for the patient and the target profile information is related to the prescription data of the patient.

6. The method of claim 1 wherein the marketing offer comprises a discount coupon for a medical product or service.

7. The method of claim 1 wherein the marketing offer comprises an opportunity to receive treatment at a discounted rate in exchange for joining a clinical trial for the treatment.

8. A method for facilitating marketing of medical products or services for patients, the method comprising:
reviewing medical data of a patient;
selecting one or more marketing offers for the patient based on the review; and
presenting the selected one or more marketing offers for approval.

9. The method of claim 8 wherein presenting the selected offers comprises displaying the selected offers to the doctor for approval for the patient.

10. The method of claim 8 wherein presenting the selected offers comprises printing the selected offers at an office of a doctor of the patient.

11. The method of claim 8, wherein reviewing medical data comprises reviewing medical data at the office of the doctor.

12. The method of claim 8, wherein reviewing medical data comprises reviewing data about one or more prescriptions for the patient written by the doctor.

13. The method of claim 8, wherein reviewing medical data comprises reviewing medical data for the patient located at a computer of the office of the doctor.

14. The method of claim 8, wherein selecting one or more marketing offers comprises selecting one or more offers for medical products, medical treatments, or clinical studies.

15. The method of claim 8, wherein selecting one or more marketing offers comprises selecting, from a list of marketing offers, one or more marketing offers that match the medical data of the patient.

16. The method of claim 8, further comprising presenting at the office of the doctor the printed marketing offers to the patient.

17. A system for providing marketing offers for patients of a doctor, the system comprising:
a patient profile module configured to store at least one profile describing a patient, the profile including at least one set of prescription data related to a treatment prescribed for the patient by a doctor;
a marketing storage module configured to store at least one marketing offer which may be made to a patient, each of the at least one marketing offers comprising a target profile and a benefit to be provided to the patient;
a selection module configured to choose one or more of the marketing offers to associate with the patient based upon the profile of the patient and the target profile of the one or more marketing offers; and
a display module for presenting the one or more selected offers.

18. The system of claim 17 wherein the display module comprises a printer configured to print prescription data and the one or more selected marketing offers on a form for the patient to receive at the office of the doctor.

19. The system of claim 17 wherein the display module comprises a display screen on a point-of-care device, the display screen configured to present the doctor with the marketing offer and to request confirmation that this offer is appropriate for the patient.

20. A computing device for facilitating marketing of medical products or services for patients, the computing device comprising:
at least one medical profile of a patient;
at least one marketing offer for medical products, medical services or both; and
a selection module configured to select one or more marketing offers from the at least one marketing offer based on the at least one medical profile.

21. The computing device of claim 20, the computing device being connected to a printer, the printer being configured to print out the selected marketing offers.

22. The computing device of claim 21, wherein the computing device is connected to a doctor's office and the printer is located in the doctor's office.

23. The computing device of claim 21, wherein the printer is configured to print out at least a price discount coupon for one of the selected marketing offers.

24. The computing device of claim 21, wherein the printer is configured to print out at least an advertisement for one of the selected marketing offers.

25. The computing device of claim 21, wherein the printer is configured to print out at least a clinical study enrollment offer for one of the selected marketing offers.

26. The computing device of claim 20, wherein the computing device is located in a doctor's office.

27. The computing device of claim 20, wherein the medical profile of the patient includes a diagnosis for the patient.

28. The computing device of claim 20, wherein the medical profile of the patient includes a prescription for the patient.

29. The computing device of claim 20, wherein the medical profile of the patient includes a medical test to be performed on the patient.

30. The computing device of claim 20, wherein at least one of the stored marketing offers is associated with a medical condition.

31. The computing device of claim 20, wherein at least one of the stored marketing offers is associated with a prescription.

32. The computing device of claim 20, wherein at least one of the stored marketing offers is associated with a medical test.

33. A prescription with a marketing offer related to a patient, the prescription comprising:
a form printed at a doctor's office;
prescription data related to a patient printed on the form; and
at least one marketing offer printed on the form, wherein the marketing offer is selected based upon a profile related to the patient.

34. The prescription of claim 33 wherein the prescription data represents a pharmaceutical treatment selected by a doctor.

35. The prescription of claim 34 wherein the profile is related to the prescription data.

36. A system for printing an advertisement on a prescription, the system comprising:
prescription data representing a particular prescribed treatment recommended by a doctor for a patient;
patient profile means for storing data associated with the patient;
marketing offer means for storing data associated with one or more marketing offers which may be made to the patient;
selection means for choosing one or more of the one or more marketing offers to be made to the patient; and
printing means for printing a prescription for the patient, the prescription comprising the prescription data and the one or more chosen marketing offers.
